(19) United States
(12) Patent Application Publication
(10) Pub. No.: US 2008/0161943 A1
(43) Pub. Date: Jul. 3, 2008

(54) METHODS TO PRESENT PROBLEM SOLUTIONS

(76) Inventor: Alexander Kibkalo, Sarov (RU)

Correspondence Address: Hanely Flight & Zimmerman, LLC, 150 S. Wacker Drive, Suite 2100, Chicago, IL, 60606, US

(21) Appl. No.: 11/686,917

(22) Filed: Mar. 15, 2007

Related U.S. Application Data
(63) Continuation of application No. PCT/RU06/00708, filed on Dec. 27, 2006.

(51) Int. Cl. G06Q 99/00

(52) U.S. Cl. 700/89

(57) ABSTRACT

Methods and apparatus to present solutions to problems are disclosed. An example method includes receiving a set of rules defining a problem, electronically propagating a first solution to determine a second solution and a third solution, automatically determining if a cost associated with the third solution is less than a cost associated with the second solution, storing the cost associated with the third solution as a first minimum value using an atomic operation when the cost associated with the third solution is less than the cost associated with the second solution, and displaying the third solution.

### RELATED APPLICATIONS

This patent arises from a continuation of International Patent Application No. PCT/RU2006/000708, entitled “METHODS TO PRESENT PROBLEM SOLUTIONS” which was filed on Dec. 27, 2006. International Patent Application No. PCT/RU2006/000708 is hereby incorporated by reference in its entirety.

### FIELD OF THE DISCLOSURE

This disclosure relates generally to software processes and, more particularly, to software processes for solving problems.

### BACKGROUND

The desire to increase the execution speed of computer instructions has lead to the implementation of parallel processing systems. Parallel processing systems include multiple processing units and/or multiple cores on each processing unit. Each processing core can execute computer instructions simultaneously. In addition, processes have been divided into multiple threads such that multiple threads can be executed simultaneously.

Dynamic programming refers to a programming paradigm is that may be used to solve search and optimization problems in many areas. It is based on the principle of optimality: a hypothesis (structure, object) provides an optimal solution(s) only if its parts (substructures, subobjects) are also optimal. The task solution using dynamic programming assumes a sequence (hypothesis, path) of discrete steps. A cost function is defined for all possible steps and each step contributes its cost to the cost of the hypothesis. The final cost of the hypothesis is generally equal to the sum of its step costs.

### BRIEF DESCRIPTION OF THE DRAWINGS

FIGS. 1-4 illustrate flowcharts representative of an example method to present solutions to problems.

FIG. 5 illustrates an example pseudocode implementation of the example method of FIGS. 1-4.

FIG. 6 is a block diagram of an example computer that may execute machine readable instructions to implement the example method illustrated in FIGS. 1 to 4 and/or the pseudocode of FIG. 5.

### DETAILED DESCRIPTION

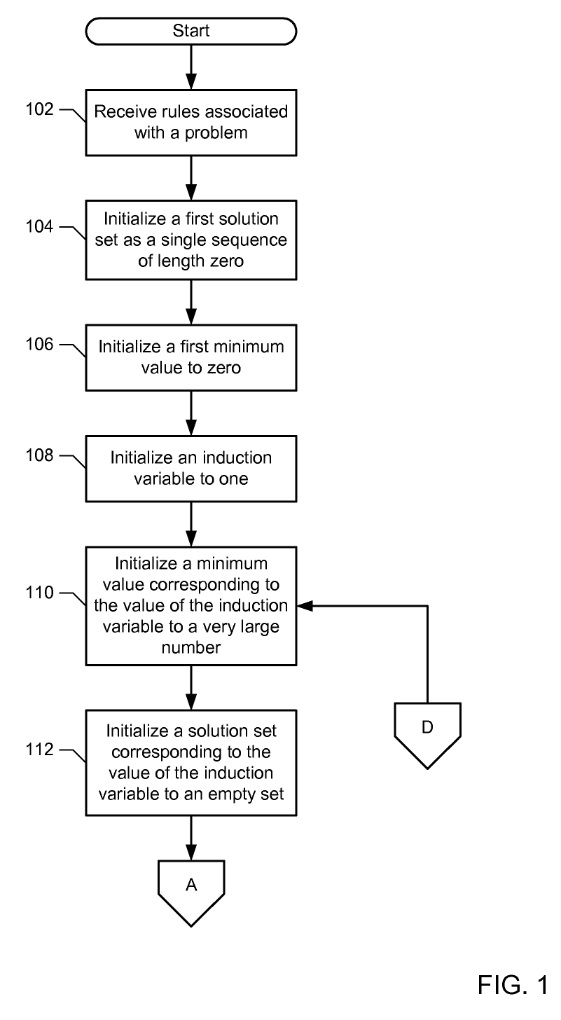

FIGS. 1-4 are flowcharts representative of an example method to present solutions to problems. For example, the methods disclosed herein may be used in a dynamic programming approach to determine an optimal solution to a problem and present the solution to a user. In general, the example method receives a set of rules defining the problem to be solved. The method uses the rules to determine and evaluate possible solutions to the problem. The example method eliminates solutions that are estimated to be less optimal (e.g., higher cost) solutions. When the method encounters a solution that is more optimal (e.g., lower cost) than any previous solution, the method atomically stores the cost of the solution as the current minimum cost. Once all likely optimal solutions have been evaluated, the method presents the solution that appears to be the most optimal (e.g., the lowest cost).

The flowchart of FIGS. 1-4 begins when the method receives rules associated with a problem to be evaluated from a user (block 102). The received rules describe the problem (e.g., the starting point and the goal for the problem) and the process to find possible solutions. For example, if the problem to be solved is the recognition of audio as words, the rules describe the possible phonemes associated with speech (e.g., vocal data) and possible words that are formed by those phonemes. In another example, the rules for evaluating a game of chess describe how the individual chess pieces move and how they interact with other pieces and describe how the game of chess is won. In yet another example, the rules for finding a route form a first point on a map to a second point on a map describe how to move from one point to another and how to locate paths from a point on a map.

After the rules associated with the problem are received, the method initializes a first solution set as a single sequence of length zero (block 104). The first solution set contains the starting point for the problem. For example, if the problem involves finding an optimal path between two points on a map, the first solution set will contain the starting location on the map.

The method then initializes a first minimum value to zero (block 106). The minimum corresponds to the lowest cost associated with the first solution set. For example, if the starting point in the first solution set is also the goal of the problem, the cost to reach the goal is zero (e.g., there is no cost because the start and goal are the same). Alternatively, the cost may be calculated in such a way that the highest “cost” is most desirable (e.g., the “cost” is the number of points scored). In this alternative, the minimum value will be a maximum value in order to maximize the “cost.”

The method then initializes an induction variable to one (block 108). The induction variable controls a loop that iterates through the processing of possible solutions. For example, the loop may iterate until the maximum solution length has been reached. The induction variable may be a part of a “for loop,” a “while loop,” a “do loop,” or any other type of loop.

The method begins the loop by initializing a minimum value corresponding to the value of the induction variable to a very large number (block 110). For example, the value may be initialized to the largest number that can be stored in the minimum value (e.g., infinity, 65,535, etc.). Alternatively, the value may be initialized to a value that is known to be the highest cost for a possible solution. For example, if the cost of one solution in the solution set is already known, the minimum value can be initialized to the cost of that solution.

The method then initializes a solution set corresponding to the value of the induction variable to an empty set (block 112). The solution set corresponding to the induction variable will be used to store the possible solutions that are found as a result of propagation of the possible solutions corresponding to the previous value of the induction variable.

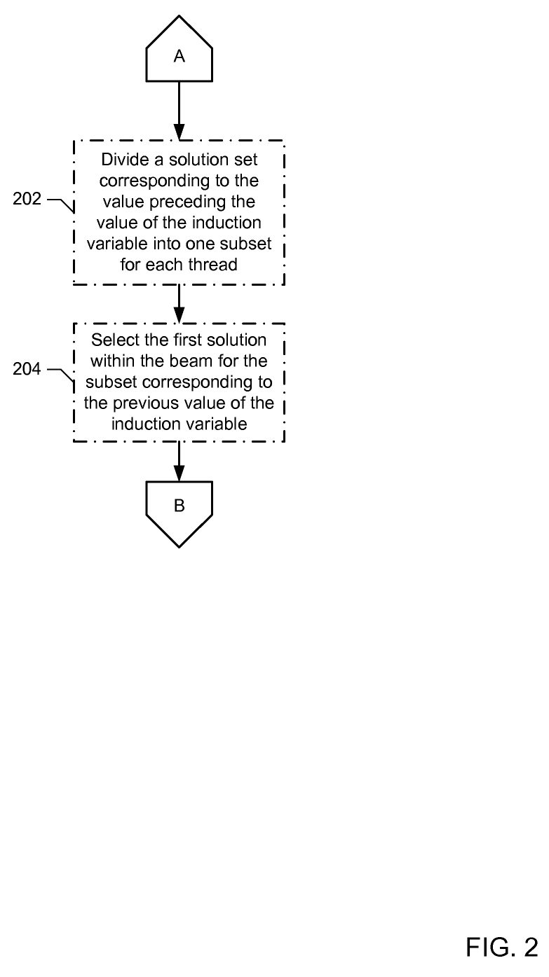

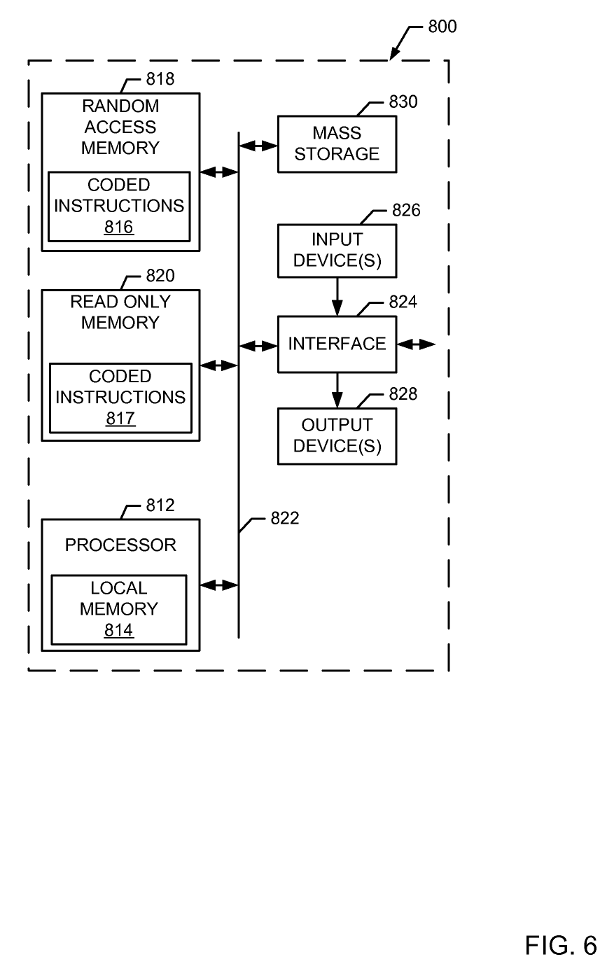

As shown in FIG. 2, the method then divides the solution set corresponding to the previous value of the induction variable into subsets (block 202). The subsets are related to the number of simultaneous operations that the method will utilize. For example, if the method is performed by a processor system (e.g., processor system 800 of FIG. 6), the subsets correspond to the number of threads and/or processing units that will perform the method. Dividing the solution set into subsets allows solutions to be evaluated in parallel. In other words, when the method is performed by multiple simultaneous operations, multiple solutions can be evaluated and propagated at the same or substantially the same time.

The portion of the method of the example illustrated by blocks 204 to 318 is performed in parallel. In other words, in a processor system, a first processing element may perform blocks 204 to 318 on a first subset of solutions at the same time that a second processing element performs blocks 204 to 318 on a second subset of solutions. Blocks 204 to 318 are illustrated with dashed lines to clearly illustrate that they are performed in parallel. However, one of ordinary skill in the art will recognize that any blocks may be performed in parallel or in serial operation. For example, the entire example method may be performed in parallel with another copy of the method or any other method.

After the solution set has been divided into subsets (block 202), the first solution having a cost within a desired beam (e.g., a range of estimated costs) is selected from the subset (e.g., the solution set assigned to the processing element) of the solution set corresponding to the previous value of the induction variable (block 204). The cost of a solution is an estimated cost that is dependent on the problem that is to be solved. For example, an estimated cost for finding a path to a destination on a map is the straight-line distance between a solution start and the goal. In the illustrated example, the desired beam encompasses costs that are greater than the minimum cost corresponding to the previous value of the induction variable plus a constant. The value of the constant depends on the problem to be solved. For example, the value may be selected by performing several searches with different values of the constant to determine a value that allows the search to be performed in a reasonable amount of time without eliminating optimal solutions. Persons of ordinary skill will recognize that any beam suitable for the received problem may be used. The beam may be used to limit the number of possible solutions that are examined by predicting which solutions are likely to be less optimal that previously evaluated solutions.

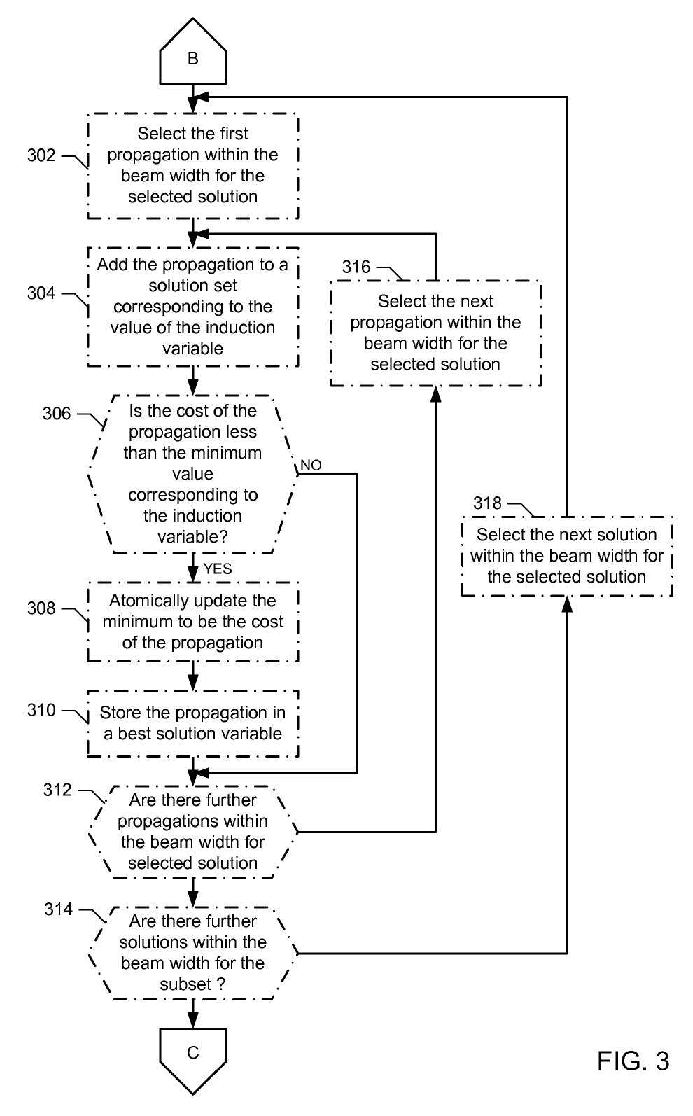

As illustrated in FIG. 3, after selecting the first solution from the previous set, the method determines and/or selects the first propagation of the selected first solution that is within the beam width (e.g., propagations outside of the beam width are not selected) (block 302). The propagation is the next step in the solution. For example, if the problem involves finding a path between nodes of a node graph, a propagation of a solution is the next node along the path from the solution (e.g., between the solution and the goal). The selected propagation, which is within the beam width, is then added to the solution set corresponding to the value of the induction variable (block 304). In other words, the propagation is added to the solution set corresponding to the current pass of the method.

After adding the propagation to the current solution set, the method determines if the cost of the propagation is less than the minimum value corresponding to the value of the induction variable (block 306). If the propagation is the first to be evaluated for the selected solution, the propagation will be less than the minimum because the minimum has been set to the greatest value possible (e.g., infinity). If the propagation is greater than the current minimum value, control proceeds to block 312.

If the cost associated with the propagation solution is less than the minimum value corresponding to the value of the induction variable (block 306), the minimum value corresponding to the value of the induction variable is atomically updated with the cost of the propagation solution (block 308). Updating the minimum value atomically prevents other operations of the method (e.g., other processing elements performing the method) from interleaving and reading and/or changing the value while the value is being updated. The value may be updated using any type of atomic operation or any other operation that can prevent interleaving. For example, the value may be updated using a “TestAnd Set” operation, a “Swap” operation, a “FetchAndAdd” operation, a “FetchAndMax” operation, a “FetchAndMin” operation, etc.

After updating the minimum value (block 308), the method stores the propagation (i.e., the propagation having the lowest cost) as the best solution (block 310). For example, the propagation may be stored in a best solution variable.

After updating the minimum and storing the best solution (blocks 308-310) or determining that the propagation cost is not less than the minimum (block 306), the method determines if there are further propagations within the beam width for the selected solution (block 312). If there are further propagations, the method selects the next propagation within the beam width for the selected solution (block 316) and control returns to block 304.

If there are no further propagations (block 312), the method determines if there are further solutions within the beam width for the subset of the solutions associated with the current operation (block 314). If there are further solutions, the method selects the next solution within the beam width for the selected solution (block 318) and control returns to block 302.

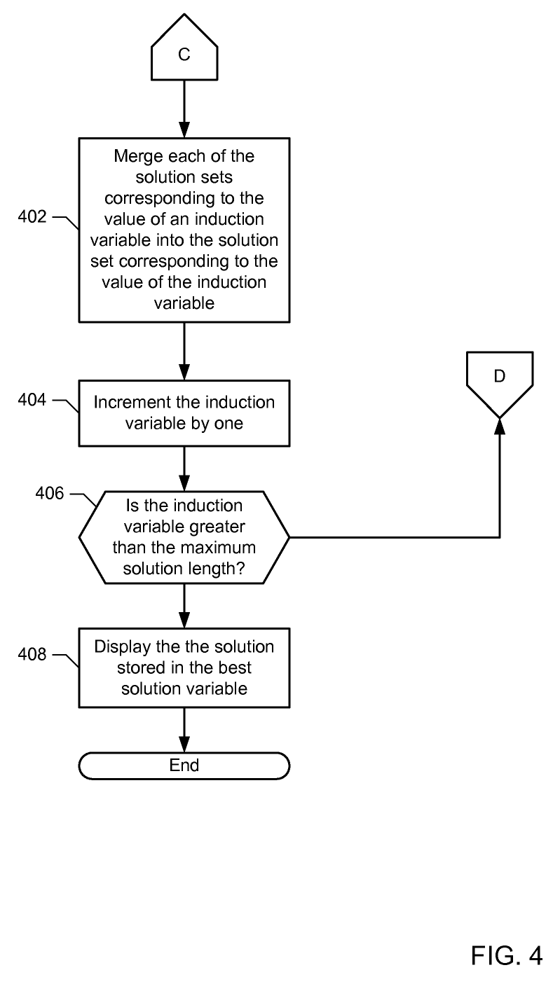

As shown in FIG. 4, if there are no further solutions within the beam width, the method merges each of the propagations of the subset that are within the beam width into the set of solutions corresponding to the induction variable (block 402). In other words, the propagations found in each of the parallel operations are merged into a single set comprising all of the propagations associated with the particular level (represented by the induction variable) in the evaluation of the problem. Then, the induction variable is incremented by one (block 404). In other words, the method moves to the next level in evaluation of the problem. The method then determines if the induction variable is greater than the maximum length for a complete solution (block 406). If the induction variable is less than the maximum length for a complete solution, control returns to block 110 of FIG. 1. If the induction variable is greater than the maximum length for a complete solution, the method displays the solution (or solutions) stored in the best solution variable and indicates that this solution is the most optimal solution located by the method. Persons of ordinary skill in the art will recognize that the best solution variable may store a single solution and/or a set of solutions.

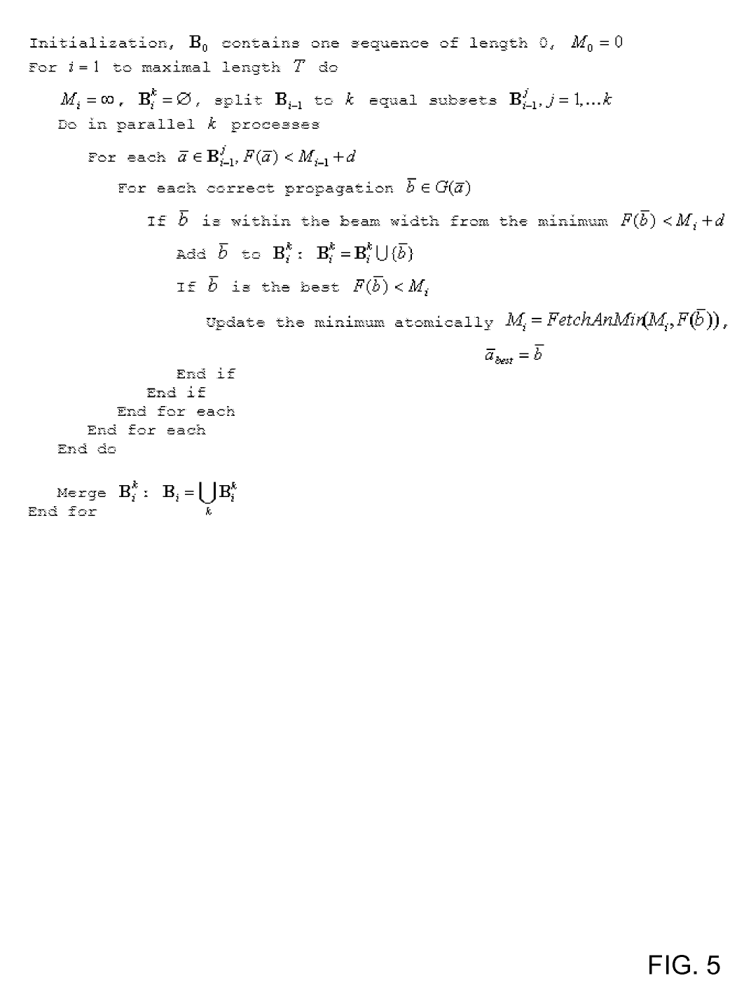

FIG. 5 illustrates an example pseudocode implementation of the method illustrated by FIGS. 1 to 4. The pseudocode implementation uses the FetchAndMin operation to atomically update the minimum value for a particular propagation.

As previously describe, the method implemented by the pseudocode of FIG. 5 may be used to display solutions for a game of chess, for recognizing spoken words as speech, and for finding the route on a map from a first point to a second point. In addition, the method may be used to solve any other type of problem, such as, for example translating words from a first language to a second language, managing a retail inventory, etc.

FIG. 6 is a block diagram of an example computer 800 capable of executing the machine readable instructions illustrated by the flowcharts in FIGS. 1 to 4 to implement method disclosed herein. In addition, the computer 800 is capable of executing machine readable instructions implementing the pseudocode illustrated in FIG. 6.

The system 800 of the instant example includes a processor 812 such as a general purpose programmable processor. The processor 812 includes a local memory 814, and executes coded instructions 816 present in random access memory 818, coded instruction 817 present in the read only memory 820, and/or instructions present in another memory device. The processor 812 may execute, among other things, machine readable instructions that implement the processes illustrated in FIGS. 1 to 4 and/or machine readable instructions that implement the pseudocode of FIG. 5. The processor 812 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 812 is in communication with a main memory including a volatile memory 818 and a non-volatile memory 820 via a bus 825. The volatile memory 818 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 820 may be implemented by flash memory and/or any other desired type of memory device. Access to the main memory 818, 820 is typically controlled by a memory controller (not shown) in a conventional manner.

The computer 800 also includes a conventional interface circuit 824. The interface circuit 824 may be implemented by any type of well known interface standard, such as an Ethernet interface, a universal serial bus (USB), and/or a third generation input/output (3GIO) interface.

One or more input devices 826 are connected to the interface circuit 824. The input device(s) 826 permit a user to enter data and commands into the processor 812. The input device(s) can be implemented by, for example, a keyboard, a mouse, a touchscreen, a track-pad, a trackball, isopoint and/or a voice recognition system.

One or more output devices 828 are also connected to the interface circuit 824. The output devices 828 can be implemented, for example, by display devices (e.g., a liquid crystal display, a cathode ray tube display (CRT), a printer and/or speakers). The interface circuit 824, thus, typically includes a graphics driver card.

The interface circuit 824 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 800 also includes one or more mass storage devices 830 for storing software and data. Examples of such mass storage devices 830 include floppy disk drives, hard drive disks, compact disk drives and digital versatile disk (DVD) drives.

As an alternative to implementing the methods and/or apparatus described herein in a system such as the device of FIG. 6, the methods and/or apparatus described herein may alternatively be embedded in a structure such as processor and/or an ASIC (application specific integrated circuit).

Although certain example methods, apparatus, and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method to present a solution to a problem, the method comprising:
receiving a set of rules defining a problem;
electronically propagating a first solution to determine a second solution and a third solution;
automatically determining if a cost associated with the third solution is less than a cost associated with the second solution;
storing the cost associated with the third solution as a first minimum value using an atomic operation when the cost associated with the third solution is less than the cost associated with the second solution; and
displaying the third solution.

2. A method as defined in claim 1, further comprising initializing the first minimum value to a largest value that can be stored.

3. A method as defined in claim 1, further comprising determining if a cost associated with a fourth solution is greater than a minimum value.

4. A method as defined in claim 3, wherein the minimum value is based on a predefined constant and a second minimum value.

5. A method as defined in claim 3, further comprising propagating the fourth solution to determine a fifth solution and a sixth solution when the cost associated with the fourth solution is less than the minimum value.

6. A method as defined in claim 1, further comprising receiving a set of solutions.

7. A method as defined in claim 6, further comprising splitting the set of solutions into subsets of solutions.

8. A method as defined in claim 7, further comprising propagating a fourth solution to determine a fifth solution and a sixth solution.

9. A method as defined in claim 8, wherein the first solution is propagated by a first processing unit of a processing system and the fourth solution is propagated by a second processing unit of a processing system.

10. A method as defined in claim 1, wherein the rules describe phonemes and the first solution, the second solution, and the third solution are words associated with input vocal data.

11. A machine readable medium having instructions stored thereon that, when executed, cause a machine to:
receive a set of rules defining a problem;
propagate a first solution to determine a second solution and a third solution;
determine if a cost associated with the third solution is less than a cost associated with the second solution;
store the cost associated with the third solution as a first minimum value using an atomic operation when the cost associated with the third solution is less than the cost associated with the second solution; and
display the third solution.

12. A machine accessible medium as defined in claim 11 having instructions stored thereon that, when executed, further cause the machine to determine if a cost associated with a fourth solution is greater than a minimum value.

13. A machine accessible medium as defined in claim 12, wherein the minimum value is based on a predefined constant and a second minimum value.

14. A machine accessible medium as defined in claim 11 having instructions stored thereon that when executed further cause the machine to:
receive a set of solutions;
split the set of solutions into subsets of solutions;
propagate a fourth solution to determine a fifth solution and a sixth solution; and
wherein the first solution is propagated by a first processing unit of a processing system and the fourth solution is propagated by a second processing unit of a processing system.

15. A method to present a solution to a problem, the method comprising:
receiving a set of rules defining a problem;
electronically propagating a first solution to determine a second solution and a third solution;
electronically propagating a fourth solution in parallel with the propagation of the first solution to determine a fifth solution and a sixth solution;
automatically determining if a cost associated with the third solution is less than a cost associated with the second solution;
storing the cost associated with the third solution as a minimum value using an atomic operation when a cost associated with the third solution is less than the cost associated with the second solution; and
displaying the third solution.

16. A method as defined in claim 15, further comprising automatically determining if a cost associated with the fifth solution is less than the minimum value.

17. A method as defined in claim 15, further comprising displaying the fifth solution when the cost associated with the fifth solution is less than the a cost associated with the sixth solution and the minimum value.

18. A machine readable medium having instructions stored thereon that, when executed, cause a machine to:
receive a set of rules defining a problem;
electronically propagate a first solution to determine a second solution and a third solution;
electronically propagate a fourth solution in parallel with the propagation of the first solution to determine a fifth solution and a sixth solution;
automatically determine if a cost associated with the third solution is less than a cost associated with the second solution;
store the cost associated with the third solution as a minimum value using an atomic operation when a cost associated with the third solution is less than the cost associated with the second solution; and
display the third solution.

19. A machine accessible medium as defined in claim 18 having instructions stored thereon that when executed further cause the machine to automatically determine if a cost associated with the fifth solution is less than the minimum value.

20. A machine accessible medium as defined in claim 18 having instructions stored thereon that when executed further cause the machine to display the fifth solution when the cost associated with the fifth solution is less than the a cost associated with the sixth solution and the minimum value.
